(19) United States
(12) Patent Application Publication
(10) Pub. No.: US 2011/0304586 A1
(43) Pub. Date: Dec. 15, 2011

(54) INFRARED TYPE HANDWRITING INPUT APPARATUS AND SCANNING METHOD

(76) Inventors: Yeh Chia-Jui, Taipei (TW); Mao Chung-Fuu, Hsin-Chu (TW); Cheng Hsiu-Feng, Hsin-Chu (TW)

(21) Appl. No.: 12/814,944

(22) Filed: Jun. 14, 2010

(51) Int. Cl. G06F 3/042

(52) U.S. Cl. 345/175

(57) ABSTRACT

An infrared type handwriting input apparatus and scanning method are disclosed. The input apparatus comprises a plurality of light emitters and a plurality of light receivers aligned along one side of a sensing area of the input apparatus, a control device and a signal processing device. The control device controls the light emitters to emit light and to control the light receivers to receive the light reflected from a pointer in the sensing area. The signal processing device processes the signals generated from the light receivers and transmits the processed signals to the control device.

### 1. FIELD OF THE INVENTION

The present invention relates to an input apparatus and a scanning method for locating the coordinates of a touch point, and more particularly to an infrared type input apparatus and a scanning method for locating the coordinates of a touch point with low cost.

### 2. DESCRIPTION OF THE PRIOR ART

Apparatuses that use touch technologies for inputting instruction or information such as touch-panel monitor can accurately locate the coordinates of touch points within effective sensing range. Among various techniques of touch panel, one technique is to place both light emitting modules and light sensor modules at corners of the screen of the display. When a pointer such as user's finger, a pen or other object contacts or approaches the screen of the display, light emitted from the light emitting modules will be reflected back to a portion of sensors of the light sensor modules. The relative angles between the location of the touch point and the positions of the sensors receiving the reflected light can be used to determine the coordinate of the touch point of the pointer through the principles of geometry and trigonometry. The advantages of this technique of detecting the coordinates of touch point include obtaining enough resolution or accuracy with few devices, etc. however, this technique of detecting the coordinates of touch point also has disadvantages including dragged responding rate. Since the detection of the touch point is performed via scanning all sensors to detect the variation of light sensing signals and the touch point usually moves continuously without rapid jump between largely spaced positions, the responding speed will be dragged if all sensors are continuously and repeatedly scanned to detect the trace of the touch point.

Another technique of detecting the coordinate of a touch point is to locate the light emitting module and the light sensor module on opposing sides of a display respectively. The position of the touch point is detected by the position of the sensor of the light sensor module which does not receive light emitted from the corresponding the light emitter of the light emitting module. That is, the location of the touch point is determined by the blocking of light by the pointer such as a user's finger or a pen. Such technique of detecting the coordinate of a touch point is widely applied upon apparatuses with a large sensing area, and the resolution depends on the number or density of the light emitters and the sensors of the light emitting module and the light sensor module respectively. Conventional input apparatuses and techniques using infrared light emitting diodes (LED) are disclosed in U.S. Pat. No. 3,764,813, U.S. Pat. No. 4,928,094, U.S. Pat. No. 5,162,783 and U.S. Pat. No. 6,677,934. These prior arts disclose light emitters and sensors on opposing sides of a display respectively. The location of the touch point is determined by the blocking of the straight light by the pointer such as an user' finger or a pen. Since the resolution of this touch technique depends on the number or density of the light emitters and the sensors as mentioned above, the light emitters and the sensors must be arranged on the sides of the sensing area with a large number and a high density in order to cover the sensing area and to have a sufficient resolution. However, such design not only increases the production cost, but also raises the difficulties of assembling. Moreover, the signal processing would be more complicated due to more signal need to be processed and more components need to be controlled.

In order to solve the above-mentioned drawbacks of the conventional input apparatus and a scanning method for locating a coordinate of a touch point, a new infrared type input apparatus and a scanning method for locating a coordinate of a touch point are thus provided.

### SUMMARY OF THE INVENTION

An object of the present invention is to provide an input apparatus and a scanning method for locating a coordinate of a touch point which arrange the light emitters and the light sensors at one side of the sensing area so as to reduce the number of devices and the cost.

According to the object of the present invention, an input apparatus is provided. The input apparatus comprises a plurality of light emitters and light sensors arranged at same one side of a sensing area of the input apparatus, a control device and a signal processing device. The control device controls the light emitters to emit light beams and the light sensors to receive the light beams reflected from a pointer in the sensing area. The signal processing device processing light sensing signals generated by the light sensors and output the processed light sensing signals to the control device.

According to the object of the present invention, a scanning method for locating a coordinate of a pointer of an input apparatus is provided. The input apparatus comprises a plurality of light emitters and light sensors arranged at same one side of a sensing area of the input apparatus and a control device, the control device controls the light emitters to emit light beams and the light sensors to receive the light beams reflected from a pointer in the sensing area. The scanning method comprises the following steps. Firstly, the control device controls one of the light emitters to emit light beams into the sensing area. Secondly, one by one the light sensors are enabled by the control device to receive the light beams reflected from the pointer. Next the steps set forth are repeated until all the light emitters had emitted light beams. Then the values of light sensing signals generated by all the light sensors are compared to determine a rough position of the pointer along a Y axis. Then the control device enables one light emitter within the region in which the light sensor has highest signal amplitude to emit light beams. Next the control device controls the light sensors one by one to receive the light beams reflected from the pointer. Then the amplitude values of light sensing signals generated by the light sensors can be used to determine precise Y coordinate of the pointer. Finally, precise X coordinate of the pointer is calculated by using the Y coordinate of the pointer and the distances between the pointer and two light sensors closest to the pointer respectively.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 shows a schematic illustration of an input apparatus of one embodiment of the present invention.

FIG. 2 shows a schematic illustration of signal emitting and receiving of an input apparatus of one embodiment of the present invention.

FIG. 3 shows the geometry used to calculate the X coordinate of the pointer in the sensing area.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

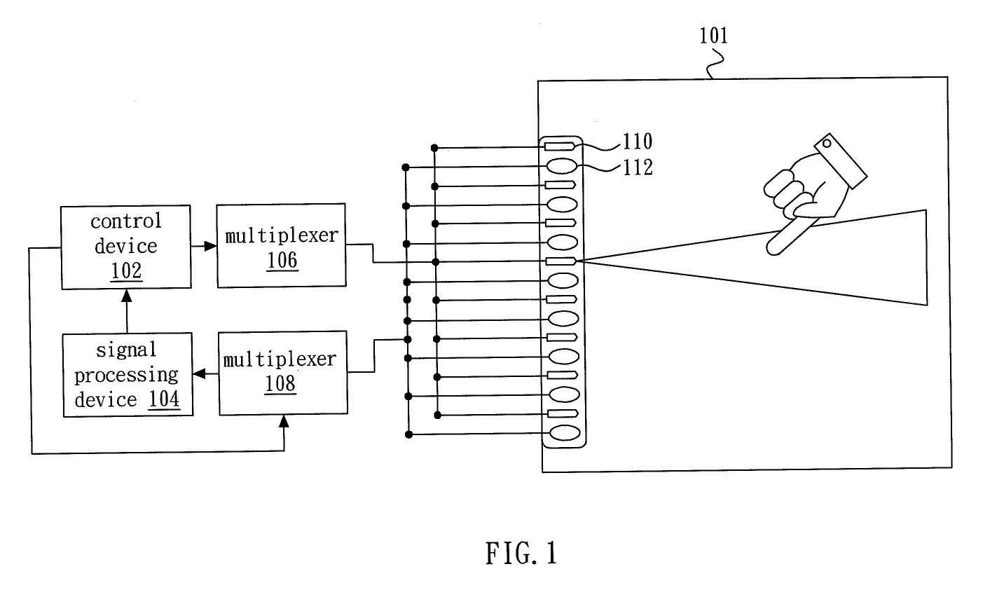

FIG. 1 shows a schematic illustration of an input apparatus of one embodiment of the present invention. The location of a pointer or indicator in a sensing area 101 such as a user's finger or a stylus is determined through the sensing signals received by light sensors 112. The sensing signals are generated from the light reflected from the pointer, wherein the maximum value of the sensing signal is generated at the light sensor 112 which is closest to the pointer. When light emitters 110 emit light in to the sensing area 101, the light sensors 112 which are located close to the pointer and with specific angles relative to the pointer will generate higher amplitude value of sensing signals resulting from the reflection of light from the pointer, while other light sensors 112 which are located more far away from the pointer will receive less strength of light and generate weaker sensing signals. Most light beams emitted from the light emitters 110 are not blocked and reflected from the pointer and will only generate much weaker sensing signals on the light sensors 112. All sensing signals generated on the light sensors 112 are then processed by a signal processing device 104 to form a curve of signal strength distribution. The coordinate of the pointer can be calculated by the signal strength distribution and suitable algorithms. That is, the coordinate of the pointer can be calculated by the strength variation of the sensing signals and suitable algorithms. The light emitters 110 and the light sensors 112 are preferably arranged in an interlaced configuration, but not limited to an interlaced configuration. The light emitters 110 are linearly arranged and each light emitter 110 is controlled by a control device 102 through a switch of a multiplexer 106. The light sensors 112 are also linearly arranged and each light sensor 112 is controlled by the control device 102 through a switch of a multiplexer 108. The control device 102 comprises a micro-controller unit (MCU), but not limited to a micro-controller unit. The light emitter 110 comprises an infrared light emitting diode (LED), but not limited to an infrared light emitting diode. The light sensor 112 comprises a charged-couple device (CCD) sensor or a complementary metal oxide semiconductor (CMOS) sensor or other photoelectric effect sensor, but not limited to a charged-couple device sensor or a complementary metal oxide semiconductor sensor. If the infrared light emitting diode is used as the light emitter 110, an infrared sensor can be used as the light sensor 112. Each light emitter 110 corresponds to a switch of the multiplexer 106 which is controlled by the control device 102. According to firmware program, the control device 102 controls the on/off and scanning modes of the light emitters 110. The light sensors 112 are turned on according the control signals from the control device 102 through the switches of the multiplexer 108 to receive light beams reflected from a pointer such as a user' finger. Light sensing signals are then generated in the light sensors 112 and are transmitted to the signal processing device 104. The light sensing signals are then processed by the signal processing device 104 and the processed light sensing signals are then transmitted to the control device 102 to calculate the coordinate of the pointer in the sensing area. It is noted that the input apparatus shown in FIG. 1 only shows a schematic configuration which only discloses main features of the invention. Other well known minor features are omitted and can be made or used according to related prior art by one with ordinary skill in the art to carry out the invention. The input apparatus of the invention can be integrated into a whiteboard or integrated with a display apparatus such as a liquid crystal display, a plasma display and a projection display, or a cathode ray tube display etc, but not limited to an electronic white board, a liquid crystal display, a plasma display a projection display or a cathode ray tube display. Various modifications may be made without departing from the scope of the present invention, which is intended to be limited solely by the appended claims. The input apparatus may integrate with a flat display including a liquid crystal display, a plasma display and a projection display, etc, but cathode ray tube displays are not excluded. The elements and devices of the above mentioned embodiments are only example, instead of limitations. It will be appreciated by those skilled in the art that various modifications may be made without departing from the scope of the present invention, which is intended to be limited solely by the appended claims.

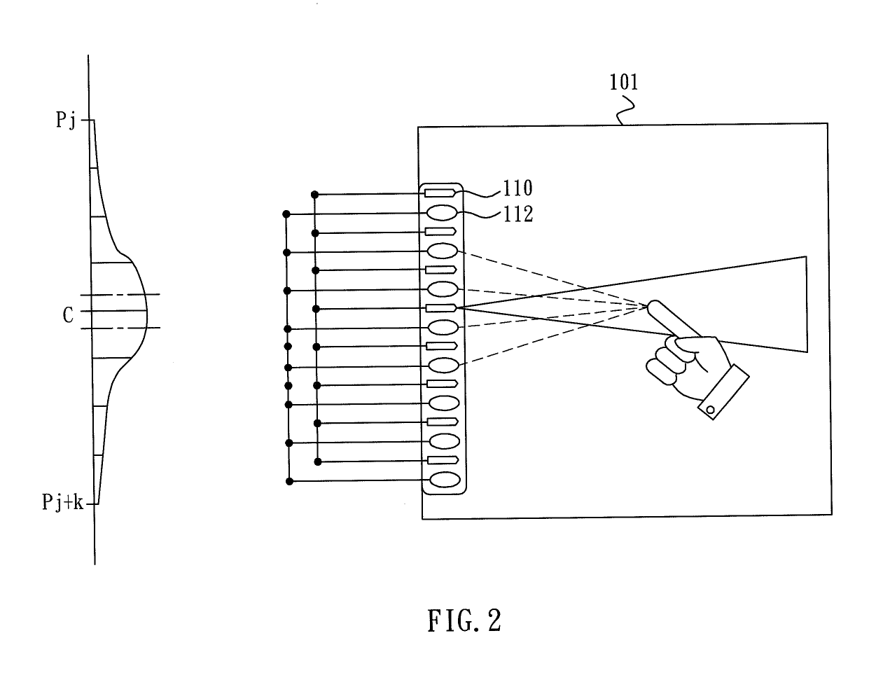

FIG. 2 shows a schematic illustration of signal emitting and receiving of an input apparatus of one embodiment of the present invention. In FIG. 2, a light emitter 110 emits light beams into the light sensing area 101, wherein a portion of the light beams are blocked and reflected from the pointer or the user's finger. The reflected light beams are received by all light sensors 112 to generate light sensing signals thereon. The strength of the light sensing signal decreases when the distance between the light sensor 112 and the pointer or the user's finger increases. The strength of the light sensing signal increases when the distance between the light sensor 112 and the pointer or the user's finger decreases. Thus a distribution of light sensing signals can be obtained. Since the light emitters 110 and the light sensors 112 are arranged along Y axis, the light sensing signals are distributed along Y axis and the Y coordinate of the pointer or user's finger can be obtained. In FIG. 2, the light sensor 112 closest to the pointer or user's finger generates the light sensing signal with a highest strength, and the signal strengths of the distribution of the light sensing signals gradually decrease from the center or peak toward two sides. The distribution of the strengths of the light sensing signals shown in FIG. 2 is generated by all light sensors 112 receiving the light beams emitted from the light emitter 110 closest to the pointer or user's finger. The distribution of the strengths of the light sensing signals generated by all light sensors 112 receiving the light beams emitted from other light emitter 110 will be different, but the light sensor 112 closest to the pointer or user's finger will generate the light sensing signal with a highest strength.

As shown in FIG. 1, in order to detect whether a pointer is in the sensing area of the input apparatus, the control device 102 controls the light emitter 110 to emits light beams and the light sensors 112 to receive the light beams reflected from the pointer or user's finger so as to calculate the coordinate of the pointer in the sensing area. The control device 102 sends control signals to the multiplexer 106 to sequentially turn on the switches so that the corresponding light emitters 110 sequentially emit light beams. The control device 102 sends control signals to the multiplexer 108 to turn on the switches and the corresponding light sensors 112 to receive the light beams. In one embodiment, a full scan on a sensing area is performed by the following steps. First of all, the control device 102 controls the multiplexer 106 to turn on a light emitter 110 to emit light beams, and the control device 102 controls the multiplexer 108 to sequentially turn on all light sensors 112 to receive the reflected light beams emitted from the first light emitter 110. Then the control device 102 controls the multiplexer 106 to turn on a second light emitter 110 to emit light beams, and the control device 102 controls the multiplexer 108 to turn on all light sensors 112 to receive the reflected light beams emitted from the second light emitter 110. The control device 102 then controls the multiplexer 106 to turn on the light emitter 110 and controls the multiplexer 108 to turn on all light sensors 112 to receive the reflected light beams until all remain light emitters 110 are sequentially turned on. If a pointer appears in the sensing area of the input apparatus, the light sensors 112 receive the light beams reflected from the pointer sequentially emitted from all light emitters 100. Since the distances between each light emitter 110/light sensor 112 and the pointer are different, the distribution of the strengths of the light sensing signals along Y axis is thus formed. The rough position/coordinate along Y axis of the pointer in the sensing area 101 can be estimated by comparing the strengths of the light sensing signals.

A partial scan on the sensing area is then performed after the rough position/coordinate along Y axis of the pointer in the sensing area 101 is determined. The control device 102 sends control signals to the multiplexer 106 to turn on the light emitters 110 closest to the rough position/coordinate along Y axis of the pointer to emit light beams. The control device 102 sends control signals to the multiplexer 108 to turn on all light sensors 112 to receive the reflected light beams emitted by this light emitter 110. The values of the signal strengths of the light sensing signals are compared according to the distribution of the signal strengths of the light sensing signals to obtain, for example, but limited to, 3 highest values of the signal strengths of the light sensing signals. The accurate Y coordinate of the pointer in the sensing area 101 can be calculated through algorithms, the distances between the light sensors 112, and the 3 highest values of the signal strengths of the light sensing signals. That is to say, the Y coordinate of the pointer in the sensing area 101 can be calculated by the following equation:

Y_{R}={(Y₁ₛₜ−Y_{2nd})/[(Y₁ₛₜ−Y_{2nd})+(Y₁ₛₜ−Y_{3rd})]}×(L×K_{R})

Y=(n−1)×(L×K_{R})+Y_{R}

wherein L (inch) is the distance between two adjacent light sensors 112, and K_{R} is the resolution per inch. Y₁ₛₜ is the highest light sensing signal value generated by the light sensor 112, Y_{2nd} and Y_{3rd} are the second and the third highest light sensing signal values generated by the corresponding light sensors 112. Y_{R} is the relative Y coordinate of the pointer relative to the light sensor 112, Y is the Y coordinate of the pointer.

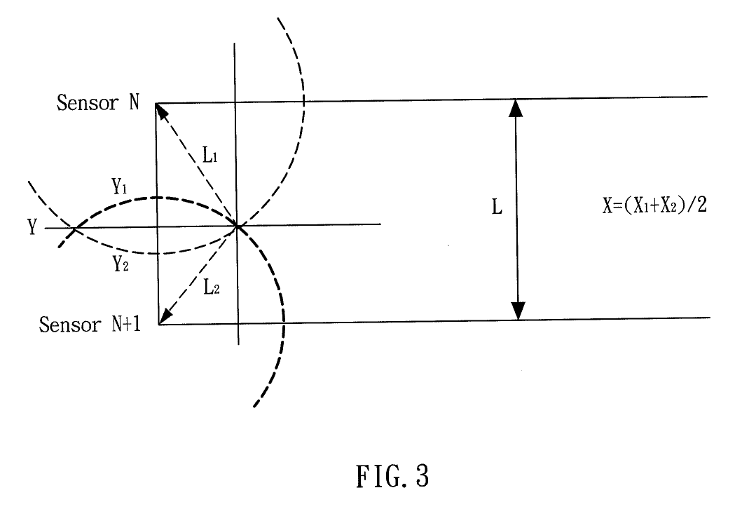

In order to calculate the X coordinate of the pointer in the sensing area 101, the geometry shown in FIG. 3 is utilized. The light sensor N is the light sensor generating the highest value of the light sensing signal, the light sensor N+1 is the light sensor generating the second highest value of the light sensing signal. Since the y coordinates of the light sensors N and N+1 are known, Y₁ and Y₂ which are the distances between the Y coordinate of the pointer and the light sensors N and N+1 respectively can be calculated, wherein Y₁ plus Y₂ equals L. L₁ and L₂ which are the distances between the pointer and the light sensors N and N+1 respectively can be obtained through the values of the light sensing signals generated by the light sensors N and N+1 since the distance between the pointer and the light sensor 112 is inversely proportional to the strength of the light sensing signal generated by the light sensor 112. X₁ and X₂ can be calculated through known Y₁ and L₁, Y₂ and L₂ respectively, wherein the distance between two adjacent light sensors 112 is L. the X coordinate of the pointer in the sensing area 101 can be calculated by the following equations:

X₁²=L₁²−Y₁²

X₂²=L₂²−Y₂²

X=(X₁+X₂)/2

The light emitters and the light sensors of the input apparatus of the invention are arranged at same one side of the sensing area. In one embodiment, the light emitters and the light sensors are arranged in an interlaced configuration so as to reduce the cost. The scanning method for locating a coordinate of a touch point includes performing full scans and partial scans on the sensing area through the corresponding firmware of the control device. The method of the invention scans all light sensors to detect the light sensor generating the light sensing signal with a highest value. Then partial scans are then performed instead of full scans. Only light emitters within a certain range adjacent the light sensor generating the light sensing signal with a highest value are scanned, such as three light emitters on each side of the light sensor generating the light sensing signal with a highest value. When the pointer moves, the partial scans are performed to detect the movement of the light sensing signal with a highest value relative to the pointer. Thus only the light sensors within a certain range adjacent the light sensors to be scanned are needed to be refreshed so that the speed of scan and tracking the pointer can be upgraded.

Although specific embodiments have been illustrated and described, it will be appreciated by those skilled in the art that various modifications may be made without departing from the scope of the present invention, which is intended to be limited solely by the appended claims.

What is claimed is:

1. An input apparatus, the input apparatus comprising:
a plurality of light emitters and light sensors arranged at one side of a sensing area of the input apparatus;
a control device, the control device controlling the light emitters to emit light beams and the light sensors to receive the light beams reflected from a pointer in the sensing area; and
a signal processing device, the signal processing device processing light sensing signals generated by the light sensors and transmitting the processed light sensing signals to the control device.

2. The input apparatus according to claim 1, wherein the light emitter comprises an infrared light emitting diode.

3. The input apparatus according to claim 1, wherein the light sensor comprises a charged-couple device sensor, an infrared sensor or a complementary metal oxide semiconductor sensor.

4. The input apparatus according to claim 1, wherein the light emitters and the light sensors are arranged at one side of the sensing area of the input apparatus in an interlaced configuration.

5. The input apparatus according to claim 1, wherein the control device controls the light emitters and the light sensors by at least one multiplexer.

6. A scanning method for locating a coordinate of a pointer of an input apparatus, the input apparatus comprising a plurality of light emitters and light sensors arranged at one side of a sensing area of the input apparatus and a control device, the control device controlling the light emitters to emit light beams and the light sensors to receive the light beams reflected from a pointer in the sensing area, the scanning method comprising:
(a) the control device controlling one of the light emitters to emit light beams into the sensing area;
(b) the control device controlling the light sensors to receive the light beams reflected from the pointer;
(c) repeating step (a) and (b) until all the light emitters emitting light beams;
(d) comparing the values of light sensing signals generated by the light sensors to determine a rough position of the pointer along a Y axis;
(e) the control device controlling at least one light emitter within a region in which the light sensors generating light sensing signals with a highest value to emit light beams;
(f) the control device controlling the light sensors to receive the light beams reflected from the pointer;
(g) comparing the values of light sensing signals generated by the light sensors to determine Y coordinate of the pointer; and
(h) calculating X coordinate of the pointer by using the Y coordinate of the pointer and the distances between the pointer and two light sensors closest to the pointer respectively.

7. The scanning method of the input apparatus according to claim 6, wherein the light emitter comprises an infrared light emitting diode.

8. The scanning method of the input apparatus according to claim 6, wherein the light sensor comprises a charged-couple device sensor, an infrared sensor or a complementary metal oxide semiconductor sensor.

9. The scanning method of the input apparatus according to claim 6, wherein in step (e) the control device controlling three light emitter within a region in which the light sensors generating light sensing signals with a highest value to emit light beams.
